(19) United States
(12) Patent Application Publication
(10) Pub. No.: US 2009/0118122 A1
(43) Pub. Date: May 7, 2009

(54) ENETRANT TRANSFER PRINTING

(76) Inventor: Semi KAO, Huatan Township (TW)

Correspondence Address: SINORICA, LLC, 528 FALLSGROVE DRIVE, ROCKVILLE, MD, 20850, US

(21) Appl. No.: 11/934,386

(22) Filed: Nov. 2, 2007

(51) Int. Cl. B41M 5/26

(52) U.S. Cl. 503/201

(57) ABSTRACT

A penetrant transfer printing method includes the step of: providing an object with a printing layer thereon, and then providing a colorless surface material on the printing layer of the object for baking to form a protective film on the printing layer of the object, and then attaching a transfer paper on the printing layer of the object for hot pressing the transfer paper. The protective film will form pores therein because of expansion of a molecule structure, and a printing ink of a pattern on the transfer paper will be molten and penetrate into the pores of the protective film to transfer the pattern of the transfer paper to the printing layer of the object. Last step of the present is peeling the transfer paper off and clearing the object.

### BACKGROUND OF THE INVENTION

1. Field of the Invention

The present invention relates generally to a printing technique, and more particularly to a penetrant transfer printing.

2. Description of the Related Art

Conventional methods of printing pattern or texture on an object include direct printing and transfer printing. Typically, transfer printing provides a transfer paper with a pattern thereon attached on the object, and then pressing and heating the transfer paper to transfer the pattern to the object. The transfer printing is a well-know technique and is broadly applied in many products, such as exercise pads and Yoga pads.

One drawback of transfer printing is that the pattern will be erased when the pattern is touched frequently. An improved technique provides a protective layer on the pattern that isolate the pattern from being touching. This method could not be applied on some kinds of products, such as exercise pads and Yoga pads that has a fabric thereon and the pattern is printed on the fabric.

### SUMMARY OF THE INVENTION

The primary objective of the present invention is to provide a penetrant transfer printing method, which provides a protective film on the printed object, and the protective film has pores between molecules when it is heated and expands so that the printing ink on the transfer paper may permeate into the pores of the protective film to have the pattern transferred to the object.

According to the objective of the present invention, a penetrant transfer printing method includes the step of: providing an object for printing a pattern thereon, wherein the object has a printing layer thereon; providing a colorless surface material on the printing layer of the object; baking the object for curing of the surface material to form a protective film on the printing layer of the object; attaching a transfer paper on the printing layer of the object; hot pressing the transfer paper to melt a printing ink of a pattern on the transfer paper and to heat the protective film to form pores therein because of expansion of a molecule structure of the protective film, therefore the molten printing ink will penetrate into the pores of the protective film to transfer the pattern of the transfer paper to the printing layer of the object; and peeling the transfer paper off and clearing the object.

### BRIEF DESCRIPTION OF THE DRAWINGS

FIG. 1 is a flow chart of a preferred embodiment of the present invention;

FIG. 2 is a sectional view of the printing layer and the protective film of the preferred embodiment of the present invention;

FIG. 3 is a sectional view of the printing layer and the protective film of the preferred embodiment of the present invention, showing the printing ink permeating into the protective film and transferring to the printing layer; and

FIG. 4 is a perspective view of a printed object made by the method of the present invention.

### DETAILED DESCRIPTION OF THE INVENTION

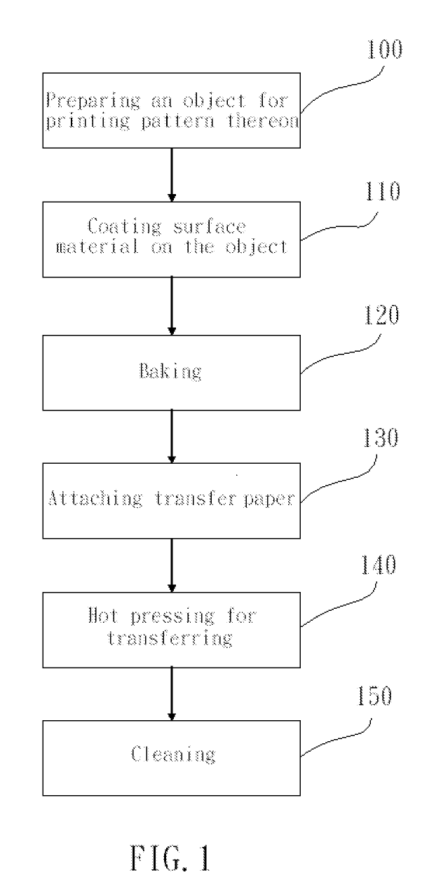

As shown in FIG. 1 to FIG. 3, a penetrant transfer printing method of the preferred embodiment of the present invention includes the following steps:

The first step 100 is preparing an object 10 for printing a pattern thereon. In the embodiment of the present invention, the object 10 is an exercise pad including a flexible pad member 11 and a printing layer 12 on the flexible pad member 11. The flexible pad member 11 is made of foaming natural rubber, and the printing layer 12 is a fiber material, such as fabric.

The second step 110 of the present invention is coating a surface material. The object 10 is sunk into a tank filled with the surface material to have a surface layer on the printing layer 12. The surface material is liquid type latex without pigment.

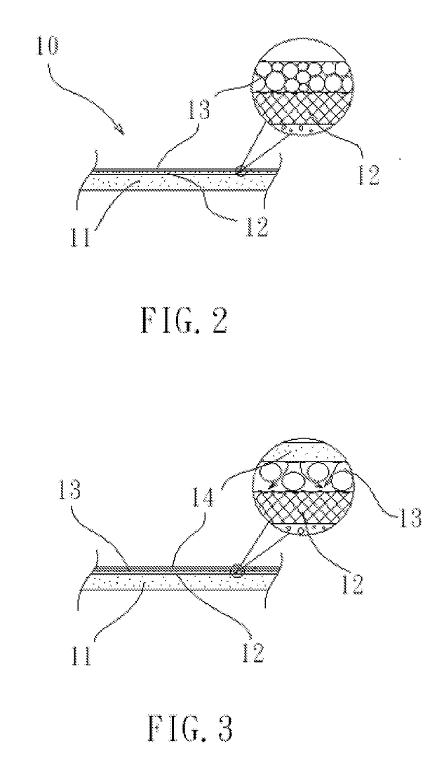

The third step 120 is baking. The object 10 is heated for curing of the surface layer to form a protective film 13 with a fin thickness, as shown in FIG. 2. The protective film 13, solid latex, has suitable skidproof property and flexibility.

The fourth step 130 is attaching a transfer paper 14. The object 10 is attached with a transfer paper 14, which has a pattern thereon, and goes through a conventional rolling device that the transfer paper 14 is attached on the protective film 13.

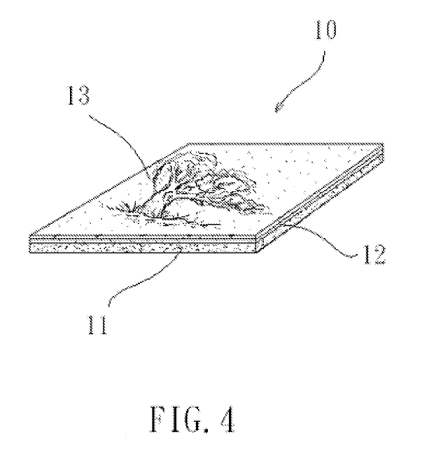

The fifth step 140 of the present invention is hot pressing for transferring the pattern. A conventional heating device provides the transfer paper a predetermined heat and pressure for a desired time to melt the pattern of the transfer paper 14 and heat the protective film 13. The molecule structure of the protective film 13 will be expanded to form pores therein to have a molten printing ink of the pattern of the transfer paper 14 penetrating into the pores of the protective film 13 that the pattern of the transfer paper 14 is transferred to the printing layer 12, as shown in FIG. 3.

The last step 150 of the present invention is cleaning step. The transfer paper 14 is peeled off to clean the object 10 to complete the transfer printing process of the present invention. When the protective film 13 cools down, the pores are vanished because of the contraction of the molecule structure. The transfer paper 14 and the object 10 are rolled up respectively.

The tank, rolling device, and the hot pressing device are conventional machines which detail structures and operation modes are not described here.

The present invention provides the object 10 formed with the protective film 13 on the printing layer 12. The protective film 13 generates pores therein when the protective layer 13 is heated to have the molten printing ink of the pattern of the transfer paper 14 penetrating into the pores and to transfer the pattern to the printing layer 12. With these, the pattern on the printing layer 12 is protected by the protective film 13. The protective film 13 has well skidproof property that the object 10 is good for using as a Yoga pad, as shown in FIG. 4. It fixes the problems of the conventional Yoga pad which the poor skidproof of the fabric on the pad member that affects Yoga exercise.

Of course, the pattern of the printing layer 12 has a poorer definition than the conventional transferring printing because of the protective layer 13 that doesn't give a fatal problem to the product. Sometime, an unclear pattern gives different kind of beauty.

It has to be mentioned that the way of forming the transparent protective film on the object is not restricted in the description of the present invention. Any method that can form a uniform protective film on the printing layer, such as coating, sputtering, or other relative methods, may be incorporated in the present invention.

What is claimed is:

1. A penetrant transfer printing method, comprising the step of:
providing an object for printing a pattern thereon, wherein the object has a printing layer thereon;
providing a colorless surface material on the printing layer of the object;
baking the object for curing of the surface material to form a protective film on the printing layer of the object;
attaching a transfer paper on the printing layer of the object;
hot pressing the transfer paper to melt a printing ink of a pattern on the transfer paper and to heat the protective film to form pores therein because of expansion of a molecule structure of the protective film, therefore the molten printing ink will penetrate into the pores of the protective film to transfer the pattern of the transfer paper to the printing layer of the object; and
peeling the transfer paper off and clearing the object.

2. The method as defined in claim 1, wherein includes the step of sinking the object in a tank filled with the surface material to form the surface material on the object.

3. The method as defined in claim 1, wherein includes the step of putting the object together with the transfer paper through a rolling device to attach the transfer paper on the protective of the object.

4. The method as defined in claim 2, wherein the printing layer is a fiber material.

5. The method as defined in claim 2, wherein the surface material is a latex without pigment.

6. The method as defined in claim 1, further comprising the step of rolling the object and the transfer paper up respectively after the step of peeling the transfer paper off and cleaning the object.

7. The method as defined in claim 1, wherein the object includes a flexible pad member, on which the printing layer is provided, and the protective film has a suitable skidproof property.
